(19) United States
(12) Patent Application Publication
(10) Pub. No.: US 2026/0028218 A1
(43) Pub. Date: Jan. 29, 2026

(54) EQUINE CONTROL SYSTEM

(71) Applicant: COCUS FORCE PTY LTD, Templestowe (AU)

(72) Inventor: Harry Andrew Petrie, Templestowe (AU)

(21) Appl. No.: 18/998,507

(22) PCT Filed: Jul. 28, 2023
(86) PCT No.: PCT/AU2023/050711

§ 371 Date: Jan. 26, 2025

(30) Foreign Application Priority Data
Jul. 29, 2022 (AU) 2022902143

(51) Int. Cl. B68B 1/10; A01K 15/02

(52) U.S. Cl. CPC B68B 1/10; A01K 15/02

(57) ABSTRACT

The present invention relates generally to a system and device for controlling an equine, and in particular, to a system and device that is worn by the equine and which is used in a racing environment for controlling the behaviour of the equine.

### RELATED APPLICATIONS

The present application claims priority from Australian provisional patent application no. 2022902143 filed 29 Jul. 2022, the entire contents of which are incorporated herein by reference.

### FIELD OF INVENTION

The present invention relates generally to a system and device for controlling an equine, and in particular, to a system and device that is worn by the equine and which is used in a racing environment for controlling the behaviour of the equine.

### BACKGROUND OF THE INVENTION

Horseracing is a well-established and popular activity in many nations around the world. Many horses, such as thoroughbreds, are bred for racing due to their natural speed and agility. Due to the popularity of wagering on horseracing, much money is invested into breeding and training horses which has resulted in the horseracing industry becoming a highly regulated industry employing a large number of people.

Horses typically race under controlled conditions with rules and regulations for racing determined by overseeing regulatory bodies. As wagering on the outcome of a race can offer large returns, the overseeing regulatory bodies spend considerable effort on employing dedicated professionals, called Stewards, to oversee the actions of the various participants to ensure the outcome and integrity of the race is maintained.

Therefore, there are rules and regulations associated with how the horses are trained and the conditions in which they race to ensure that the safety of the competing horses and jockeys is paramount and that the result of the race is fair and uncompromised. Thus, there exist numerous types of equipment that have been endorsed by the regulatory bodies to be worn by the horse and/or carried by the jockey to maximise the effort put in by the horse to win a race. Such types of equipment include whips, saddles and other equipment that provide a degree of control over the horse's behaviour during a race.

Blinkers or blinders refer to equipment that is worn by a horse in the form of a hood with eye cups. Horses can generally see across 320° without having to move their heads. Due to such a wide vision range, a horse can become distracted by a variety of items that may enter their vision range and alter their behaviour. Such distractions can cause the horse to become agitated and react adversely, resulting in the horse expending unnecessary energy, which is undesirable during a race. To address this, blinkers or blinders function by limiting the horse's field of vision during a race. Such equipment is relatively common at a racetrack and is a tool used by most horse trainers to address behavioural issues of a horse to minimise the horse becoming distracted and agitated to ensure that they perform to their maximum potential during a race.

Horses have generally two types of vision, monocular vision and binocular vision. Monocular vision enables a horse to see across 320°, almost completely around their body and behind them due to their eyes being set on the side of their head. This type of vision has been important in the evolution of horses as they are prey animals and such monocular vision enables a horse to be alert to the presence of predators, even when they have their heads down while grazing. Due to the horse's eyes being towards the front of their head, they also have binocular vision that allows them to focus on what is directly ahead of them.

Blinkers are typically employed to limit the horse's monocular vision and therefore what is available for the horse to see, in an attempt to improve the horse's focus. Whilst horses may react to the effect of blinker's differently, it is generally established that with such an improved focus, the horse may break from the starting gates or barriers faster as they are not as distracted by the handlers and other horses at the barriers. Similarly, some horses may be reactive to seeing a rider on their back and the use of blinkers removes the rider from their field of vision to reduce this effect. However, the increased focus provided by the blinkers may also have an adverse effect on the horse's performance during a race. This can result in the horse becoming so focussed on the racetrack ahead of them that the jockey is unable to slow or “rate” the horse during a race such that they are unable to conserve the horse's energy to finish off the race appropriately.

Thus, whilst blinkers may be a useful tool to aid in controlling a horse to increase their focus during one part of the race, they may have a detrimental impact on the horse's performance during another part of the race. For this reason, other devices such as cheaters or winkers have been employed. Such devices function to only partially limit the field of vision of the horse to a much lesser extent than blinkers. Whilst such variations exist, their ability to focus the horse only on the racetrack ahead of them is removed as they allow some monocular vision which can distract the horse. Thus, in such situations the jockey is often only able to use the whip to impact upon the horse's ability to focus and race. This is not ideal as many sections of the public view the jockey's use of the whip as being cruel and unjust to the animal.

Thus, there is a need to provide an apparatus or system of devices that provides the ability for the jockey to focus the horse only on the racetrack ahead of them in the manner in which blinkers do, but which can be selectively activated by the jockey to be used at times when such focus is necessary.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a control device for an animal, comprising:
at least one cup member configured to at least partially cover at least one eye of the animal;
an electrochromic member applied to the at least one cup member to extend at least partially over the cup member; and
an activation device for controlling a state of the electrochromic member;
wherein, the activation device controls the state of the electrochromic member to be in either an opaque state or a transparent state such that when the electrochromic member is in the opaque state the cup member at least partially restricts the field of vision of the animal and when the electrochromic member is in the transparent state the cup member does not substantially restrict the field of vision of the animal.

The control device may comprise a hood adapted to be positioned over a head of the animal, the hood having a pair of eye openings to accommodate the animal's eyes.

The at least one cup member may be mounted to the hood to extend at least partially about the eye openings of the hood.

The electrochromic member may be applied to an inner or outer surface of the at least one cup member. In one form, the at least one cup member may comprise a base member and a cover member mounted over the base member and wherein the electrochromic member may be positioned between the base member and the cover member of the at least one cup member.

The electrochromic member may be in the form of a film. The film may be a Polymer-Dispersed Liquid Crystal (PDLC) film comprising liquid crystals dispersed in a polymer matrix. The (PDLC) film may be enclosed in an electrically conductive film in communication with the activation device. The electrically conductive film may be an Indium Tin Oxide (ITO) polyethylene terephthalate (PET) film.

The activation device may include a power supply for supplying electrical stimulus to the electrochromic member to change the state of the electrochromic member.

The activation device may be mounted on the hood. In one form, the activation device may be activated by a rider of the animal to control the state of the electrochromic member. The activation device may comprise a switch that is actuable by a rider of the animal to control delivery of electrical current to the electrochromic member. In another form, the activation device may be remotely activated to control the state of the electrochromic member.

The activation device may comprise an indicator to provide the rider with an indication of the state of the electrochromic member.

The animal may be an equine.

Accordingly, in another aspect of the invention there is provided a control device for an animal, comprising:
at least one cup member configured to at least partially cover at least one eye of the animal;
a opaque film mounted with respect to the at least one cup member so as to be movable over a surface of the of the at least one cup member between a retracted position and an extended position; and
an activation device for moving the opaque film between the retracted and the extended position;
wherein, when the opaque member is in the retracted position the cup member does not substantially restrict the field of vision of the animal and when the opaque member is in the extended position the cup member at least partially restricts the field of vision of the animal.

### BRIEF DESCRIPTION OF THE DRAWINGS

The invention may be better understood from the following non-limiting description of preferred embodiments, in which:

FIG. 1 is a blinker/blinder arrangement as is known in the prior art.

FIG. 2 depicts a blinker/blinder arrangement of the present invention with the cup in the opaque state;

FIG. 3 depicts a blinker/blinder arrangement of the present invention with the cup in the transparent state;

FIG. 4 is a cross sectional view of a portion of the cup of the blinker/blinder arrangement of the present invention in the opaque state;

FIG. 5 is a cross sectional view of a portion of the cup of the blinker/blinder arrangement of the present invention in the transparent state;

FIG. 6 is an exploded side view of the cup member of the blinker/blinder arrangement of the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The apparatus of the present invention will be described below in relation to its use in controlling a racehorse during a race. However, it will be appreciated that the apparatus could be used in a variety of different applications, outside of racing, for controlling an animal, other than a horse, by restricting the animal's field of view. Further, the present invention will be described below in relation to use as a conventional blinker/blinder. However, it will be appreciated that the present invention could be adapted for use as a quarter cup, slotted cup, or a cheater and still fall within the intended scope of the present invention.

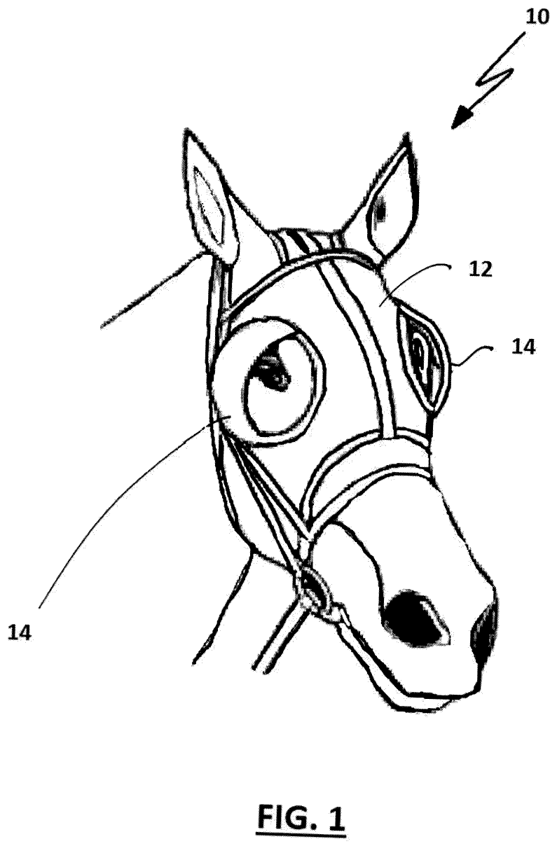

Referring to FIG. 1, there is disclosed a conventional blinker/blinder arrangement 10 in accordance with the prior art. The blinker arrangement 10 comprises a hood 12 that is configured to be fitted over the head of the horse as shown. The hood 12 is essentially worn on the horse's forehead and has holes formed therein through which the horse's ears protrude and an additional hole to accommodate the horse's muzzle. Straps may be employed to secure the hood 12 in place. The hood 12 is typically worn under a bridle and is made from a canvas type material although other types of materials are also envisaged to provide comfort to the horse when worn. Eye recesses 13 are also formed in the hood 12 to accommodate the horse's eyes as shown.

Cups 14 are secured to the hood 12 about the eye recesses 13. The cups 14 are typically half cups, but may be full cups, quarter cups or any percentage therebetween, and are made from a rubber or plastic material that is opaque. Such cups 14 and are generally configured to cover around 50% of the eye recess 13, extending from the rear thereof. In some embodiments the cups 14 do not fully enclose the eye recesses and are open at the front, as depicted. When worn in this manner, the cups 14 limit the horse's field of vision such that they can only see what is directly ahead, namely in their binocular field of vision. The cups 14 may be made from a plastic or hard rubber material such that they maintain their structure during use.

It will be appreciated that the blinker arrangement 10 of FIG. 1 is typically worn by the horse to alter their behaviour such that the horse is more focussed on the path directly ahead of them, rather than being distracted by numerous other objects that they may see in their monocular vision. However, it will be appreciated that due to the nature of the arrangement 10, it is not possible to vary the amount of the horse's vision that is limited by the cups 14 during a race, especially if the horse becomes too focussed and difficult for the jockey to restrain or “rate”.

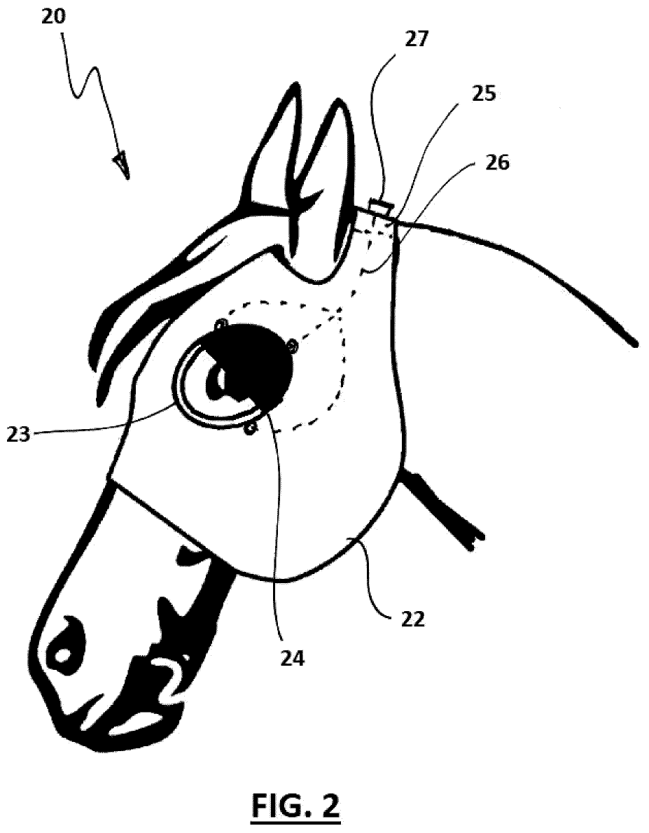

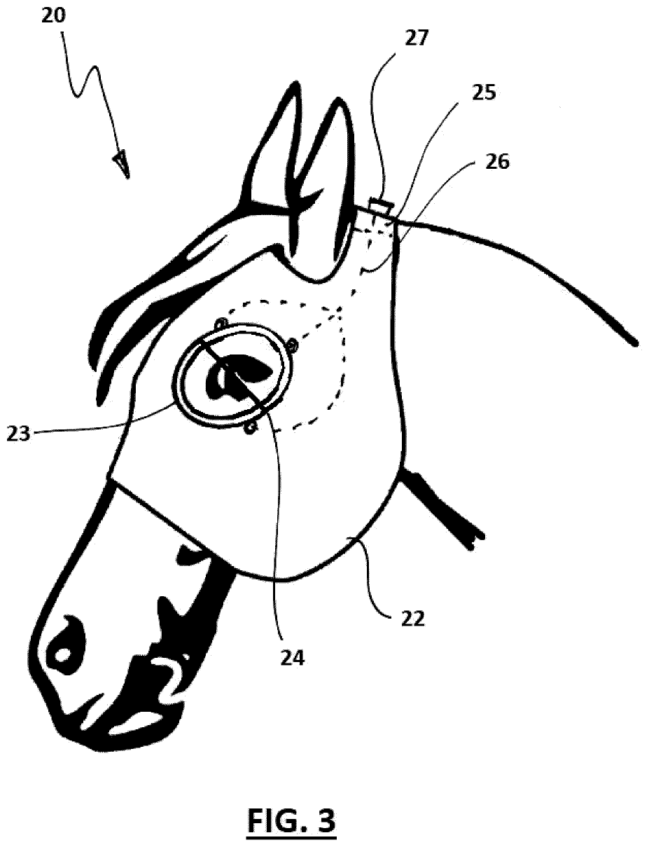

For this purpose, the blinker arrangement 20 of the present invention is proposed, as depicted in FIG. 2 and FIG. 3. The blinker arrangement 20 is configured to function in much the same manner as the prior art blinker arrangement 10 depicted in FIG. 1. In this regard, the blinker arrangement 20 comprises a hood 22 configured to be fitted over the head of the horse. The hood 22 extends over the horse's forehead and to the back of the head of the horse and has recesses to accommodate the horse's ears. Straps may extend under the horse's head to retain the hood 22 in the position as shown.

Eye recesses 23 are provided in the hood 22 to accommodate the horse's eyes when the hood 22 is fitted. Cups 24 are mounted over each of the eye recesses 23. The cups 24 are depicted as being half cups in that they cover around 50% of the eye recess 23, extending from the rear of the eye recess 23 so as to be open at the front of the eye recess. It will be appreciate that the amount of coverage of the eye recesses provided by the cups 24 may vary depending upon the needs of the horse and in some instances, only one cup 24 may be employed. The cups 24 are substantially rigid in form such that they retain their shape during use.

The cups 24 contain an electrochromic material embedded therein that functions to substantially prevent the horse from seeing through the cup 24 when in a non- activated state. FIG. 2 represents the cups 24 in the non-activated state, with the cup 24 being opaque or non-transparent, thereby preventing the horse from seeing therethrough. By activating the cups 24, an electrical charge is applied across the embedded electrochromic material to cause the cups to change from opaque to transparent. This allows the horse to see through the cups 24 in the manner as depicted in FIG. 3. In this activated state, the horse has full monocular vision and the cups 24 are transparent and offer minimal effect to control the behaviour of the horse. It will be appreciated that in the activated state the cups may be clear, although the materials forming the cup may be colour tinted.

A controller 25 is provided on the hood 22, which houses the power source required to activate the cups 24 and retain the cups 24 in the activated state, when desired. Typically, the power source is in the form of one or more batteries that can supply power to the electrochromic material embedded in the cups 24. The batteries may be rechargeable as desired. The controller may also house a microcomputer having transmitter/receiver functionality to capture data associated with the device which can be uploaded to a remote computer system to monitor the use of the device.

A switch 27 is provided on the hood 22 to be in electrical communication with the controller 25 so as to activate/deactivate the cups 24. In the embodiment as shown, the switch 27 is mounted on an upper portion of the hood 22 such that it is readily accessible by the rider of the horse. In this regard, upon depressing the switch 27, the electrochromic material will be either connected or disconnected from the power source to convert the blinker arrangement between a functioning blinker system that restricts the horse's monocular vision, or a transparent cup that does not substantially restrict the horse's monocular vision. A wire 26 may connect the controller 25 to each of the cups 24 to provide wired connection to the power source contained within the controller 25. In an alternative embodiment the controller may be connected by way of a wireless connection to an activation switch.

An indicator (not shown), such as a light or LED, may be provided adjacent the switch 27 to provide a visual indication to the rider of the state of the cups 24. If the indicator is ‘on’ this can indicate to the rider that the blinker system 20 is functioning as a conventional blinker and if the indicator is ‘off’, this can indicate that the cups 24 of the blinker system 20 are in the transparent configuration. The opposite arrangement can also be employed for the indicator. As will be discussed below, in the non-activated state where the cups 24 are not connected to the power source, the electrochromic material in the cups will be opaque and the blinker arrangement 20 will function as a conventional blinker. In the activated state, namely when power is supplied to the cups 24, the cups will become transparent. As such, the indicator will aid in providing a visual indication to assist the rider, and other observers, in determining the operational state of the blinker arrangement during a race.

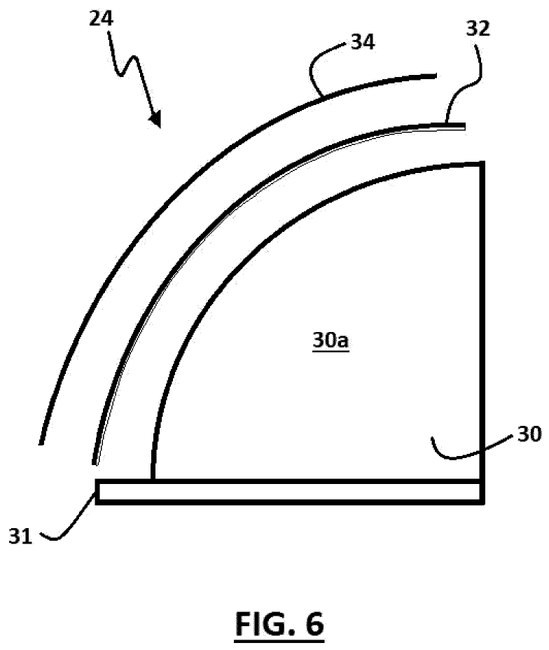

Referring to FIG. 6, a cup 24 of the blinker arrangement 20 of the present invention is depicted. The cup 24 comprises a base member 30 having a quarter-sphere shape with a rim 31 provided around a bottom surface thereof. The base member 30 may be made from a transparent acrylic material, or may be formed from a polycarbonate material or a silicone material, that is transparent or see-through. The rim 31 is provided to assist in securing the cup 24 to the hood 22, which may be done through the application of an adhesive or through stitching, as will be appreciated by those skilled in the art.

The electrochromic material 32 is secured to the outer surface of the base member 30 by way of an adhesive, such that it covers the curved outer surface 30a of the base member 30. The electrochromic material 32 is typically cut to size to cover the outer surface 30a of the base member 30. In one embodiment, the electrochromic material 32 is a Polymer-Dispersed Liquid Crystal (PDLC) film comprising liquid crystals dispersed in a polymer matrix that is enclosed in an electrically conductive ITO (Indium Tin Oxide) PET film. The PDLC film may have a conductive copper strip provided along an edge thereof to facilitate connection to the wire 26 to receive power from the controller 25. It will be appreciated that other electrochromic materials may also be employed.

A cover member 34 is mounted over the electrochromic material 32 such that the electrochromic material 32 is sandwiched between the cover member 34 and the base member 30. The cover member 34 is preferably made from the same material as the base member 30 so as to be transparent or see-through. The cover member is adhered to the outer surface electrochromic material 32 to form a sealed, laminated cup 24.

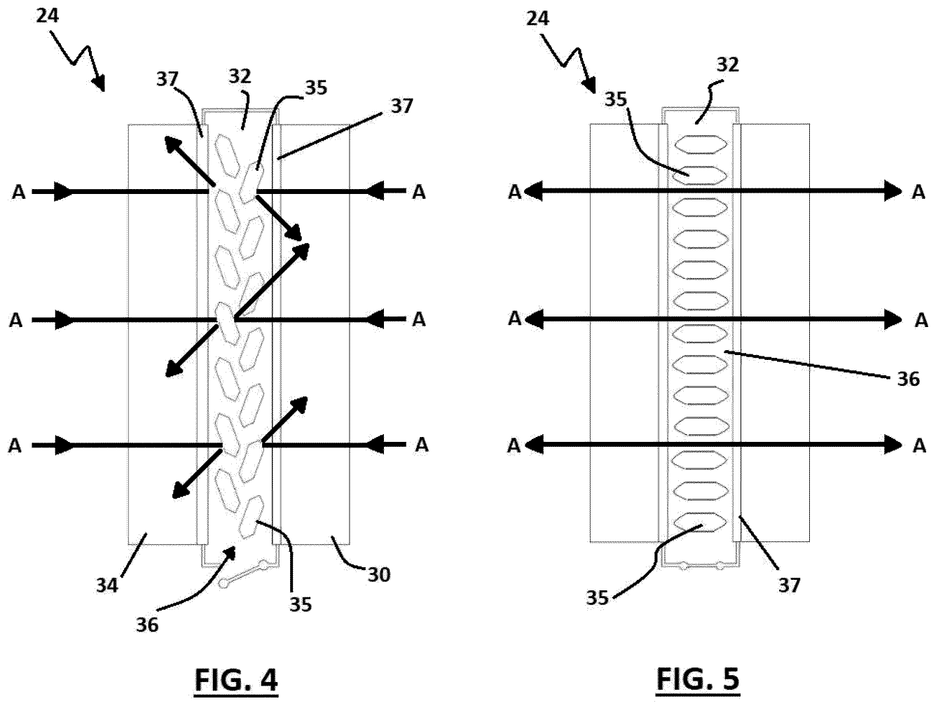

The manner in which the cup 24 functions during use is depicted in FIG. 4 and FIG. 5.

In FIG. 4, the cup 24 is in the non-activated state with no power supplied to the electrochromic material 32. As is shown, the liquid crystals 35 in the PDLC film 36 are randomly arranged such that light (arrows A) is prevented from passing through the electrochromic material 32 from either side thereof. In this state, the cup 24 is opaque and functions as a conventional blinker.

In FIG. 5, power is supplied to the electrochromic material 32 such that the cup is in an activated state. The supplied current flows through the electrically conductive ITO (Indium Tin Oxide) PET film 37, thereby causing the liquid crystals 35 present in the PDLC film 36 to become aligned. In this configuration light (arrows A) can pass through the electrochromic material 32 from either side thereof. The cup 24 then becomes transparent. In this state, the cup 24 has no substantial effect on reducing the horse's vision.

With the arrangement as depicted in FIGS. 2-6, the blinker arrangement 20 can be simply activated or deactivated through the switch 27 to connect/disconnect the cups 24 from the power supply. In doing so the blinker can be employed/deployed in accordance with the rider's requirements. The ability to control when the blinkers are employed during a race provides a rider with an additional means for controlling the horse that may obviate the need for the rider to employ the whip or similar means to urge the horse to the finish line. Such an outcome will have considerable appeal to racing authorities as it removes the need for the jockey to apply the whip during the race, thereby overcoming many negative connotations associated with whip use.

The blinker arrangement 20 of the present invention provides a simple means by which a jockey or rider can tailor the use of blinkers to suit the racing requirements of the horse. As some horses will react differently to blinkers within a race, the jockey can utilise the blinker arrangement 20 of the present invention to assist the horse to focus on the race in a manner that is more suited to the specific horse's nature. This is significantly different to existing blinker arrangements which are on at all times with no ability to be deactivated.

As the blinker arrangement of the present invention employs a computer controller 25, it may be possible for the controller to determine and record the state of the blinkers within a race at all times. This may involve the controller measuring the time in which the blinkers are activated/deactivated and the position around the track where this has occurred. This information can be transmitted from the controller 25 to course officials and/or spectators to inform them of such changes in the horse's racing conditions. Similarly, the controller 25 may include a receiver capable of receiving signals from a transmitter which can remotely activate the blinker. This may be relevant where a rule may be introduced by authorities to ban use of the whip or crop in the last 200 metres of a race, such that all blinkers are activated/deactivated automatically to maintain the same racing conditions for all horses in a race. An electronic sensor device may also be used to monitor the state of the blinker unit and transmit a signal to the Stewards during a race indicative of the state of the blinker, or when the blinker has been activated. The Stewards can then determine whether the device was used in an appropriate manner and activated at the appropriate time, as governed by racing laws.

It will be appreciated that whilst the cup 24 of the blinker arrangement of the present invention has been described as being a cup that extends across 50% of the eye recess, it is also envisaged that the cup 24 could cover any proportion of the eye recess as deemed necessary. In this regard, the cup 24 could be a quarter cup that covers 25% of the eye recess, a full cup that covers 100% of the eye recess, or any other range of coverage.

To obviate the need to provide a power supply or battery with the controller 25, an alternative version of the present invention (not shown) is provided. In such an alternative version, the electrochromic material 32 as depicted in FIG. 6 may be replaced with a sheet of opaque material sandwiched between the cover member 34 and the base member 30. The opaque sheet of material may be sheet of plastic material that is free to move within the space formed between the base member and the cover member, in a sliding manner. One end of the opaque sheet of material may be attached to a wire that can be extended upon activation to move the opaque sheet of material from a collapsed or concealed state to an extended state that covers a percentage of the base member 30. Due to the transparent nature of the cover member 34 and the base member 30, when the opaque sheet of material is in the collapsed or concealed state, the blinker arrangement does not function to restrict the field of vision of the horse. However, when the opaque sheet of material is moved to the extended state, the opaque sheet of material substantially extends over the surface of the base member 30 to function as a conventional blinker that restricts the monocular vision of the horse. Similarly, the opaque material may be positioned over the outer surface of the cover member 34 or the base member 30 (if the cover member 34 is absent).

In another embodiment, the cup 24 may be configured such that the electrochromic material 32 is removed and the cover member 34 and the base member 30 form a sealed space therebetween. In this regard, a fluid source, such as a gel or dye may be in fluid communication with the cup 24 such that upon activation of the blinker the fluid is injected into the space between the cover member 34 and the base member 30 to substantially fill the space with the fluid. The fluid will form an opaque film over the base member 30 to substantially limit vision of the horse through the cup 24. The fluid source may be pressurised such that upon release into the cup 24, the fluid immediately fills the space between the cover member 34 and the base member 30 to activate the blinker arrangement.

Irrespective of how the blinker arrangement of the present invention may be employed during a race, the ability to have a variable blinker arrangement that provides a jockey/rider with another means for controlling the behaviour of the horse during a race is extremely beneficial. Access to such a passive control means offers significant advances in relation to animal welfare as well as ensuring that maximum effort can be extracted from the horse during a race. The ability to activate/deactivate blinkers at a time during the race that best suits the natural behavioural instincts of a horse enables trainers to tailor the use of the blinker arrangement to their horse's needs for greater success on the racetrack.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

1. A control device for an animal, comprising:
at least one cup member configured to at least partially cover at least one eye of the animal;
an electrochromic member applied to the at least one cup member to extend at least partially over the cup member; and
an activation device for controlling a state of the electrochromic member;
wherein, the activation device controls the state of the electrochromic member to be in either an opaque state or a transparent state such that when the electrochromic member is in the opaque state the cup member at least partially restricts the field of vision of the animal and when the electrochromic member is in the transparent state the cup member does not substantially restrict the field of vision of the animal.

2. A control device according to claim 1, further comprising a hood adapted to be positioned over a head of the animal, the hood having a pair of eye openings to accommodate the animal's eyes.

3. A control device according to claim 2, wherein the at least one cup member is mounted to the hood to extend at least partially about the eye openings of the hood.

4. A control device according to claim 1, wherein the electrochromic member is applied to an inner or outer surface of the at least one cup member.

5. A control device according to claim 1, wherein the at least one cup member comprises a base member and a cover member mounted over the base member and wherein the electrochromic member is positioned between the base member and the cover member of the at least one cup member.

6. A control device according to any one of the preceding claims, wherein the electrochromic member is a film.

7. A control device according to claim 1, wherein the activation device includes a power supply for supplying electrical stimulus to the electrochromic member to change the state of the electrochromic member.

8. A control device according to claim 2, wherein the activation device is mounted on the hood.

9. A control device according to claim 8, wherein the activation device is activated by a rider of the animal to control the state of the electrochromic member.

10. A control device according to claim 2, wherein the activation device is remotely activated to control the state of the electrochromic member.

11. A control device according to claim 6, wherein the electrochromic member is a Polymer-Dispersed Liquid Crystal (PDLC) film comprising liquid crystals dispersed in a polymer matrix.

12. A control device according to claim 11, wherein the (PDLC) film is enclosed in an electrically conductive film in communication with the activation device.

13. A control device according to claim 12, wherein the electrically conductive film is an Indium Tin Oxide (ITO) polyethylene terephthalate (PET) film.

14. A control device according to claim 9, wherein the activation device comprises a switch that is actuable by a rider of the animal to control delivery of electrical current to the electrochromic member.

15. A control device according to claim 14, wherein the activation device comprises an indicator to provide the rider with an indication of the state of the electrochromic member.

16. A control device according to any one of the preceding claims, wherein the animal is an equine.
